(19) United States
(12) Patent Application Publication
(10) Pub. No.: US 2012/0062867 A1
(43) Pub. Date: Mar. 15, 2012

(54) LASER DISTANCE MEASUREMENT APPARATUS

(76) Inventor: Kazuhiro SHIBATANI, Osaka (JP)

(21) Appl. No.: 13/227,900

(22) Filed: Sep. 8, 2011

(30) Foreign Application Priority Data
Sep. 10, 2010 (JP) 2010-202946
Sep. 14, 2010 (JP) 2010-205946

(51) Int. Cl. G01C 3/08

(52) U.S. Cl. 356/4.01

(57) ABSTRACT

A laser-radar distance measurement apparatus for measuring the distance between two arbitrary points on a measurement target in a non-contact fashion has a light emitter, a light receiver, a scanner, and a calculation controller. The light emitter emits laser light. The scanner deflects the laser light from the light emitter to irradiate with the laser light the two arbitrary points on the measurement target one after the other, and performs one-dimensional scanning along a straight line including the two arbitrary points. The light receiver receives the laser light reflected from the two arbitrary points to output signals respectively. The calculation controller calculates the distance between the two arbitrary points based on the signals output from the light receiver and operation information on the scanner.

This application is based on Japanese Patent Application No. 2010-202946 filed on Sep. 10, 2010 and Japanese Patent Application No. 2010-205946 filed on Sep. 14, 2010, the contents of which are hereby incorporated by reference.

### BACKGROUND OF THE INVENTION

1. Field of the Invention

The present invention relates to laser distance measurement apparatus, for example, laser-radar distance measurement apparatus for measuring point-to-point distances with respect to walls and pillars of buildings, and laser-radar distance measurement apparatus provided with a function of measuring areas of wall faces, floor faces, pieces of land, etc.

2. Description of Related Art

There has conventionally been demand for measuring an arbitrary point-to-point distance (the distance between two arbitrary points) in a non-contact fashion. To achieve that, there have been proposed various laser distance measurement apparatus, of which some are already commercially available. For example, there is known a laser distance meter, as disclosed in Non-Patent Document 1 listed below, which measures a point-to-point distance in a measurement mode relying on the Pythagorean theorem (single-Pythagorean, double-Pythagorean, combination-Pythagorean, etc.). Patent Document 1 discloses a laser distance measurement apparatus that measures a point-to-point distance by performing distance measurement operation twice, the first-time distance measurement operation involving the measurement of the angle between the directions of the two points as measurement targets. Though not designed to measure an arbitrary point-to-point distance, there is also known a dimension measurement system (Patent Document 2 listed below) that employs laser light.
Patent Document 1: JP-A-2005-156203
Patent Document 2: JP-A-2002-328008
Non-Patent Document 1: A press release “Bosch Launches Two Models of Laser Distance Meters”, March 2010 (Bosch), on the Internet, <URL: http://www.bosch.co.jp/jp/press/pdf/rbjp-100301-01.pdf>.

There has conventionally been demand also for measuring the area of an arbitrary polygon in a non-contact fashion. To achieve that, there have been proposed laser distance measurement apparatus provided with a function of measuring areas, of which some are already commercially available. For example, Non-Patent Document 1 listed above discloses a laser distance meter that measures areas in a measurement mode (such as wall face area measurement mode) relying on the Pythagorean theorem. Moreover, Patent Document 1 listed above discloses a laser distance measurement apparatus that measures point-to-point distances, and Patent Document 2 listed above discloses a dimension measurement system that employs laser light.

Inconveniently, conventionally proposed laser distance measurement apparatus require complicated measurement maneuvering. For example, with the laser distance meter disclosed in Non-Patent Document 1, it is necessary to form a right-angled triangle, and the measurement of an arbitrary point-to-point distance or of the area of an arbitrary polygon in a non-contact fashion can only be achieved through a plurality of sessions of distance measurement. With the laser distance measurement apparatus disclosed in Patent Document 1, the measurement of the angle involves manual maneuvering, and the measurement of a point-to-point distance is troublesome. With a dimension measurement system employing laser light, like that disclosed in Patent Document 2, it is impossible to measure an arbitrary point-to-point distance, and the processing for calculating the dimension takes lone time. Moreover, with the laser distance measurement apparatus disclosed in Patent Document 1 and the dimension measurement system disclosed in Patent Document 2, not only is it impossible to measure the area of an arbitrary polygon, but simply measuring a length requires manual maneuvering which is troublesome, and in addition calculation processing takes long time.

### SUMMARY OF THE INVENTION

An object of the present invention is to provide a laser distance measurement apparatus that can measure an arbitrary point-to-point distance or the area of an arbitrary polygon in a non-contact fashion by simple measurement maneuvering.

According to one aspect of the invention, a laser-radar distance measurement apparatus for measuring the distance between two arbitrary points on a measurement target in a non-contact fashion is provided with: a light emitter for emitting laser light; a scanner for deflecting the laser light from the light emitter to irradiate with the laser light the two arbitrary points on the measurement target one after the other, the scanner being capable of one-dimensional scanning along a straight line including the two arbitrary points; a light receiver for receiving the laser light reflected from the two arbitrary points to output signals respectively; and a calculation controller for calculating the distance between the two arbitrary points based on the signals output from the light receiver and operation information on the scanner.

According to another aspect of the invention, a laser-radar distance measurement apparatus for measuring the area of an arbitrary polygon on a measurement target in a non-contact fashion is provided with: a light emitter for emitting laser light; a scanner for deflecting the laser light from the light emitter to irradiate with the laser light vertices of the arbitrary polygon on the measurement target, the scanner being capable of two-dimensional scanning on a surface including the arbitrary polygon; a light receiver for receiving the laser light reflected from the vertices of the arbitrary polygon to output signals respectively; and a calculation controller for calculating the area of the arbitrary polygon based on the signals output from the light receiver and operation information on the scanner.

### BRIEF DESCRIPTION OF THE DRAWINGS

FIG. 1 is a sectional view schematically showing a laser distance measurement apparatus according to a first embodiment of the invention;

FIG. 2 is a schematic diagram illustrating the measurement of the distance from the laser distance measurement apparatus to a measurement target;

FIG. 3 is a sectional view schematically illustrating how an arbitrary point-to-point distance on a measurement target is measured;

FIG. 4 is a perspective view showing a first specific example of the scanner used in the laser distance measurement apparatus;

FIG. 5 is a perspective view showing a second specific example of the scanner used in the laser distance measurement apparatus;

FIG. 6 is a plan view showing the external appearance of the laser distance measurement apparatus;

FIGS. 7A to 7D are schematic diagrams illustrating how a point-to-point distance is specified with the laser distance measurement apparatus;

FIG. 8 is a schematic diagram showing how a line segment between two points is pictorially indicated by laser-scanning;

FIG. 9 is a schematic diagram showing an example of how the laser distance measurement apparatus is used;

FIG. 10 is a flow chart showing the control for switching measurement modes in the laser distance measurement apparatus;

FIG. 11 is a flow chart showing the control for measuring a point-to-point distance in the laser distance measurement apparatus;

FIG. 12 is a sectional view schematically showing a laser distance measurement apparatus according to a second embodiment of the invention;

FIG. 13 is a sectional view schematically illustrating how an arbitrary point-to-point distance on a measurement target is measured;

FIG. 14 is a graph showing the coordinates of vertices of an arbitrary polygon on a measurement target;

FIG. 15 is a plan view showing the external appearance of the laser distance measurement apparatus;

FIGS. 16A to 16D are schematic diagrams illustrating how two points are specified with the laser distance measurement apparatus;

FIG. 17 is a schematic diagram illustrating how a third point is specified in the laser distance measurement apparatus;

FIG. 18 is a schematic diagram showing how a polygonal shape is pictorially indicated by laser-scanning;

FIG. 19 is a diagram showing a polygon divided for area measurement;

FIG. 20 is a diagram illustrating the area of a divided triangle; and

FIG. 21 is a schematic diagram showing how the laser distance measurement apparatus is used.

### DETAILED DESCRIPTION OF PREFERRED EMBODIMENTS

Hereinafter, laser distance measurement apparatus etc. embodying the present invention will be described with reference to the accompanying drawings. Among different embodiments and examples, identical or equivalent components are identified by the same reference signs, and no overlapping description is repeated unless necessary.

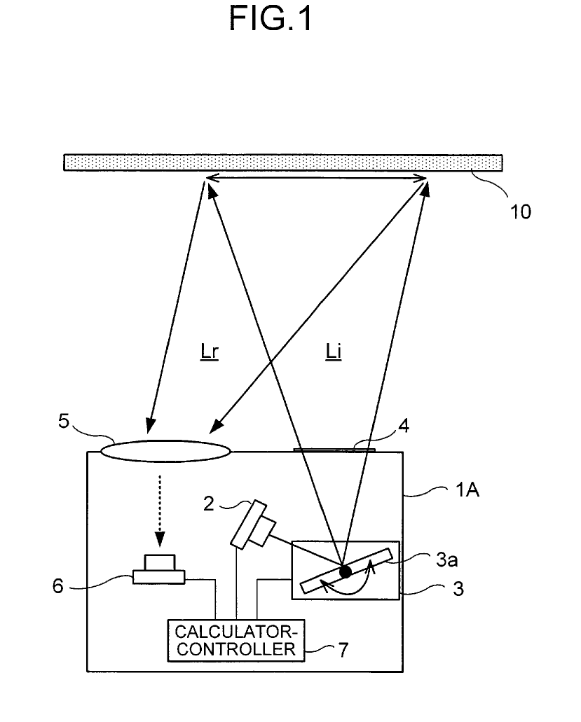

### Embodiment 1 (FIGS. 1 to 11)

FIG. 1 is a schematic diagram of a laser distance measurement apparatus 1A incorporating a scanner 3. The laser distance measurement apparatus 1A is a laser-radar distance measurement apparatus that measures an arbitrary point-to-point distance (the distance between two arbitrary points) on a measurement target 10 in a non-contact fashion, and is provided with a laser diode (LD) 2, a scanner 3, an emission window 4, a reception lens 5, a photodiode (PD) 6, a calculator-controller 7, etc.

The laser diode 2 serves as a light emitter that emits laser light, and is here assumed to be a visible-light laser diode that emits visible light as laser light. The light emitter may be constituted of an infrared laser diode that emits infrared light as laser light and a visible-light laser diode that emits visible light as laser light so that infrared light is used for distance measurement while visible light is used for pictorial indication.

The scanner 3 is so configured as to reflect and thereby deflect, with a mirror 3a, the laser light from the laser diode 2 so that the surface of the measurement target 10 is scanned with the laser light one-dimensionally. The scanner 3 here is assumed to be a one-dimensional scanner that reflects and thereby deflects laser light with a mirror 3a. It may instead be a two-dimensional scanner that reflects and thereby deflects laser light with a mirror 3a. In that case, the irradiation of the two arbitrary points is achieved by deflecting the laser light in one scanning direction. A specific structure of the scanner 3 will be described in detail later.

The photodiode 6 serves as a light receiver that receives the laser light (the reflection light Lr) reflected from the measurement target 10 and outputs a signal. The calculator-controller 7 performs predetermined calculation based on output signals from the photodiode 6 etc. and operation information on the scanner etc., and drives and controls the scanner 3 etc.

The laser light emitted from the laser diode 2 is reflected on the mirror 3a in the scanner 3, and emerges through the emission window 4 as emission light Li, with which the measurement target 10 is irradiated. The laser light reflected from the measurement target 10 (the reflection light Lr) is condensed by the reception lens 5, and is detected by the photodiode 6. A signal based on the detection by the photodiode 6 is fed to the calculator-controller 7, which then calculates, among others, the distance from the laser distance measurement apparatus 1A to the measurement target 10.

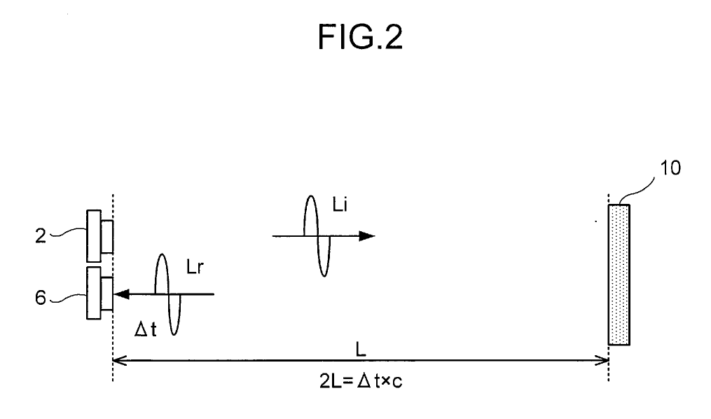

In the measurement of an arbitrary point-to-point distance on the measurement target 10, the distance from the laser distance measurement apparatus 1A to the measurement target 10 is used. And in the measurement of the distance from the laser distance measurement apparatus 1A to the measurement target 10, a TOF (time of flight) method is used. As shown in FIG. 2, suppose that the laser diode 2 and the photodiode 6 are located at equivalent positions, let the distance from the laser distance measurement apparatus 1A to the measurement target 10 be L, and let the time required for the laser light emitted from the laser diode 2 to return to the photodiode 6 after being reflected on the measurement target 10 (the go-and-return time between the laser distance measurement apparatus 1A and the measurement target 10) be Δt. Distance L is given by the formula L=(Δt/2)×c (where c represents the speed of light), and therefore determining time Δt makes it possible to determine distance L. The time Δt used in a TOF method is the difference in time between when the laser diode 2 emits light and when the photodiode 6 receives it, and can thus be calculated by the calculator-controller 7.

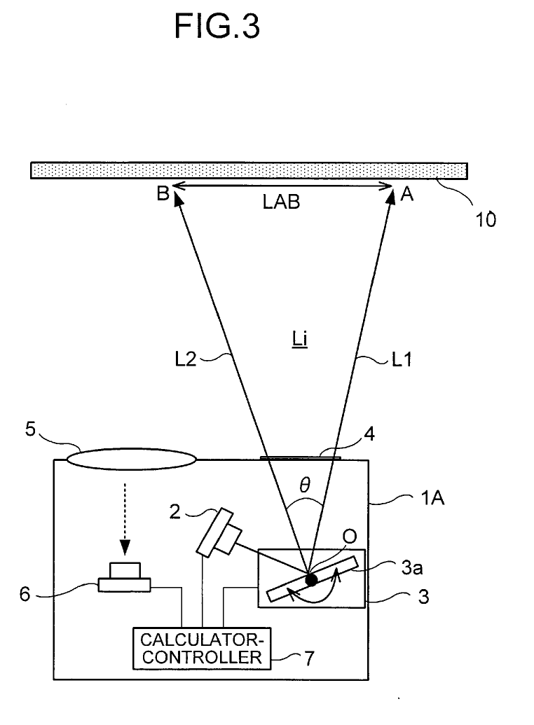

Furthermore, in the measurement of an arbitrary point-to-point distance on the measurement target 10, the angle between the line segments connecting the deflection position of the laser light (the position where the laser light is deflected) to the two arbitrary points respectively is used. As shown in FIG. 3, the scanner 3 is so configured as to deflect the laser light from the laser diode 2 in such a way that two arbitrary points A and B on the measurement target 10 are irradiated with the laser light one after the other and to scan along the straight line including those two points A and B one-dimensionally. Thus, the angle θ between the line segments OA and OB connecting the deflection position O of the laser light Li to the two arbitrary points A and B respectively can be determined based on the swing angle of the scanner 3.

As shown in FIG. 3, let the distance between the arbitrary points A and B (the length of line segment AB) be LAB, let the distance from the deflection position O of the laser light Li to point A (the length of line segment OA) be L1, and let the distance from the deflection position O of the laser light L1 to point B (the length of line segment OB) be L2. Distances L1 and L2 can be calculated based on the results of measurement by a TOF method (subtracting the distance from the laser diode 2 to the deflection position O from distance L gives distances L1 and L2), and angle θ can be determined from the swing angle of the scanner 3. Based on these values, distance LAB can be calculated according to the law of cosines:

LAB=\sqrt{L1²+L2²−2×L1L2 cos θ}

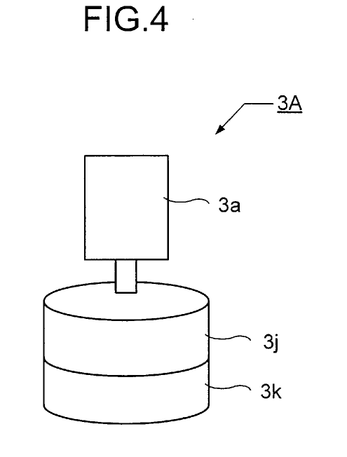

FIG. 4 shows a one-dimensional scanner 3A. The one-dimensional scanner 3A is a first specific example of the scanner 3, and is composed of a mirror 3a, a motor 3j, an encoder 3k, etc. As described above, the scanner 3A is so configured as to reflect and thereby deflect the laser light from the laser diode 2 in such a way that two points A and B on the measurement target 10 are irradiated with the laser light one after the other, and in addition to scan along the straight line including the two points A and B one-dimensionally. Specific examples of the motor 3j include a galvanometric motor, a stepping motor, and an ultrasonic motor.

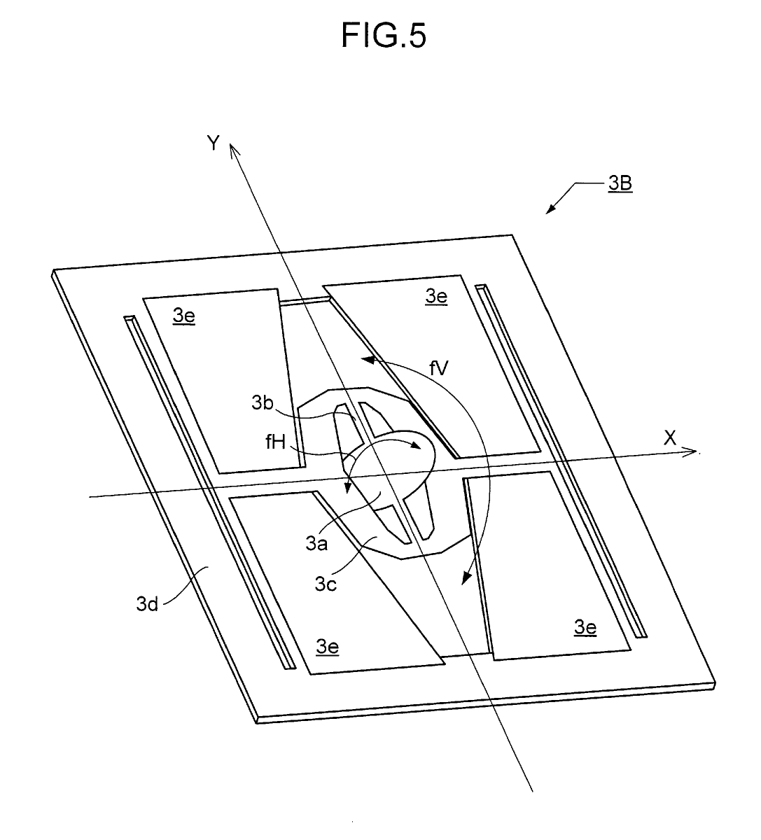

FIG. 5 shows a MEMS (micro-electro-mechanical systems) scanner 3B. The MEMS scanner 3B is a second specific example of the scanner 3. Known MEMS mirrors include those of an electromagnetic type, an electrostatic type, and a piezoelectric type. The example here is of the piezoelectric type. The MEMS scanner 3B is constituted of a substrate of etched silicon, with four pieces of PZT (lead zirconate titanate) 3e, as piezoelectric elements, bonded on the substrate to form four unimorphs extending from a fixed frame 3d. The four unimorphs are, at their portions along the X axis, coupled to a mirror holding frame 3c, and in the mirror holding frame 3c, a mirror 3a is provided on a torsion bar 3b.

The MEMS scanner 3B, by reflecting and thereby deflecting laser light with the mirror 3a, functions as a two-dimensional scanner; the MEMS scanner 3B displaces the four PZT pieces 3e to make the mirror holding frame 3c swing about the X axis, and thereby achieves vertical (longitudinal) scanning in raster scanning (fV=60 Hz). Simultaneously, the MEMS scanner 3B applies vibration at the resonance frequency (fH=30 kHz) of the oscillating portion constituted of the minor 3a and the torsion bar 3b to induce resonant vibration about the Y axis, and thereby achieves horizontal (lateral) scanning in raster scanning. Here, however, no vertical scanning is performed (fV=0 Hz); the laser light is reflected and deflected only horizontally so as to irradiate two points A and B on the measurement target 10 with the laser light one after the other and to scan along the straight line including the two points A and B one-dimensionally.

The MEMS scanner 3B of the piezoelectric type can be driven either by resonance frequency or by voltage control (low frequency). In a case where the MEMS scanner 3B is driven by voltage control, the swing angle can be detected based on the applied voltage. On the other hand, since the swing angle of the MEMS scanner 3B corresponds to the angle θ between line segments OA and OB, in a case where the MEMS scanner 3B is driven by resonance frequency, the swing angle θ is calculated according to the formula θ=α sin ωΔt. Here, α represents the amplitude of the swing angle in resonant vibration (previously known), and ω represents the resonance frequency. The applied voltage is a sinusoidal voltage, and the swing angle θ can be determined based on the timing of voltage application. The swing angle θ can also be determined based on the applied voltage.

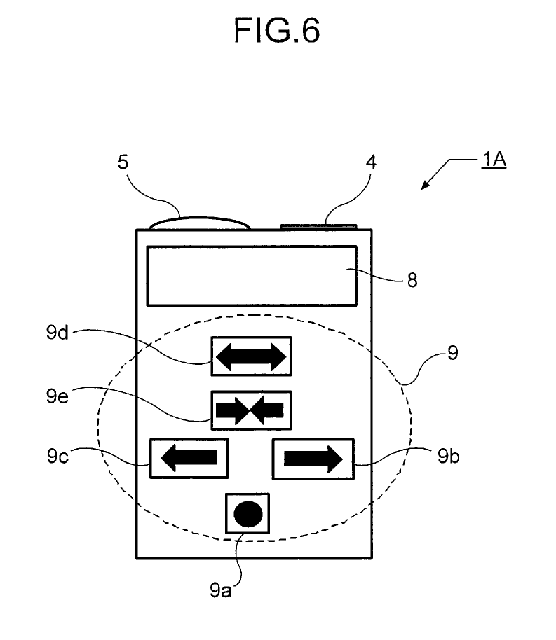

FIG. 6 shows the exterior appearance of the laser distance measurement apparatus 1A. The laser distance measurement apparatus 1A is, on the surface of its casing, provided with a display section 8, an operation section 9, etc. The display section 8 is a section that displays, among others, the result of measurement of a point-to-point distance LAB (FIG. 3). The operation section 9 is a section that the user operates to move the spot irradiated with the laser light Li (FIGS. 1 to 3) to specify the position of the point-to-point distance LAB to be measured; having specified the position, the user then operates the operation section 9 to start measurement. As buttons for allowing such operations, there are arranged a set button 9a, a shift right button 9b, a shift left button 9c, a lengthen button 9d, and a shorten button 9e in the operation section 9.

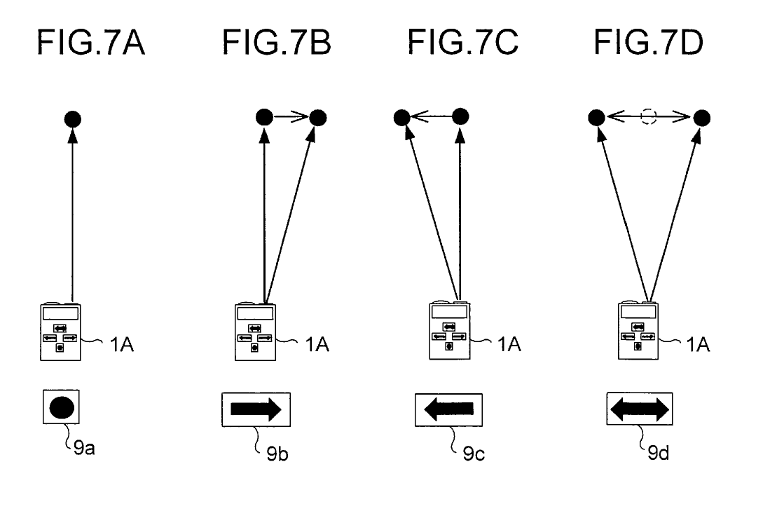

Next, a description will be given of how the user specifies a point-to-point distance LAB (FIG. 3) on the operation section 9. When the user turns on a measurement start switch (unillustrated) of the laser distance measurement apparatus 1A, point A setting mode goes into effect. In point A setting mode, as shown in FIG. 7A, the surface of the measurement target 10 (FIG. 3) is irradiated with laser light and a first laser spot is shown on it. The user moves the laser distance measurement apparatus 1A to set the laser spot at point A. With the first laser spot set at point A, the user presses the set button 9a. This puts point B setting mode into effect.

In point B setting mode, a second laser spot is shown superimposed on the first laser spot. To set the second laser spot at point B, the user uses the shift right button 9b, the shift left button 9c, the lengthen button 9d, and the shorten button 9e. For example, if the user wants to move the second laser spot rightward, as shown in FIG. 7B, he can do so by pressing the shift right button 9b. If the user wants to move the second laser spot leftward, as shown in FIG. 7C, he can do so by pressing the shift left button 9c.

If the user wants to lengthen the interval between the first and second laser spots, as shown in FIG. 7D, he can do so by pressing the lengthen button 9d. Inversely, if the user wants to shorten the interval between the first and second laser spots, he can do so by pressing the shorten button 9e (FIG. 6). With the first and second laser spots set at positions A and B, the user presses the set button 9a to fix positions A and B as distance measurement positions. When positions A and B are thus fixed as distance measurement positions, distance measurement operation is started.

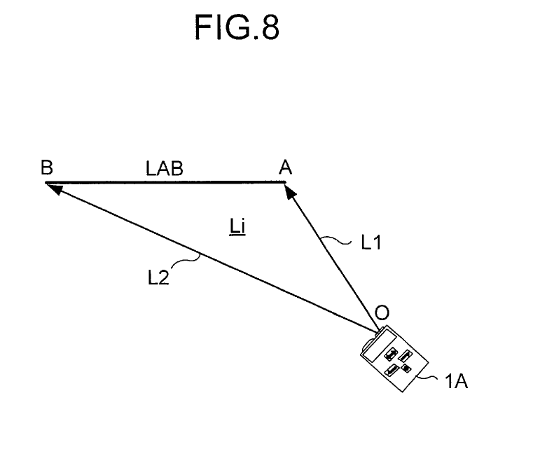

Since the laser light emitted from the laser diode 2 is visible light, by making the scanner 3 perform one-dimensional scanning with it, it is possible to pictorially indicate the two points A and B, or the line segment AB between those two points A and B, on the measurement target 10. For example, by pictorially indicating two points A and B as shown in FIGS. 7B to 7D, it is possible to indicate the point-to-point distance LAB currently being measured by showing its opposite ends. Alternatively, as shown in FIG. 8, by pictorially indicating line segment AB, it is possible to indicate the point-to-point distance LAB currently being measured by showing line segment AB.

The pictorial indication described above is achieved by controlling the light emission timing of the laser diode 2. It may instead be achieved by controlling the swing angle θ of the scanner 3. That is, the pictorial indication is achieved by the calculator-controller 7 (FIGS. 1 and 3) controlling at least either the light emission timing of the laser diode 2 or the swing angle θ of the scanner 3.

In a case where the pictorial indication is achieved by controlling the light emission timing of the laser diode 2, while the scanner 3 is operating, the mirror 3a keeps vibrating with a fixed rotation angle Θ(Θ>θ); meanwhile, the encoder 3k detects the swing angle θ, and the laser diode 2 emits light with predetermined timing. On the other hand, in a case where the pictorial indication is achieved by controlling the swing angle θ of the scanner 3, while the scanner 3 is operating, the encoder 3k detects the swing angle θ, and the mirror 3a vibrates with a rotation angle Θ(Θ=θ) corresponding to the light emission of the laser diode 2. Accordingly, for example, in the state shown in FIG. 7A, Θ=θ°.

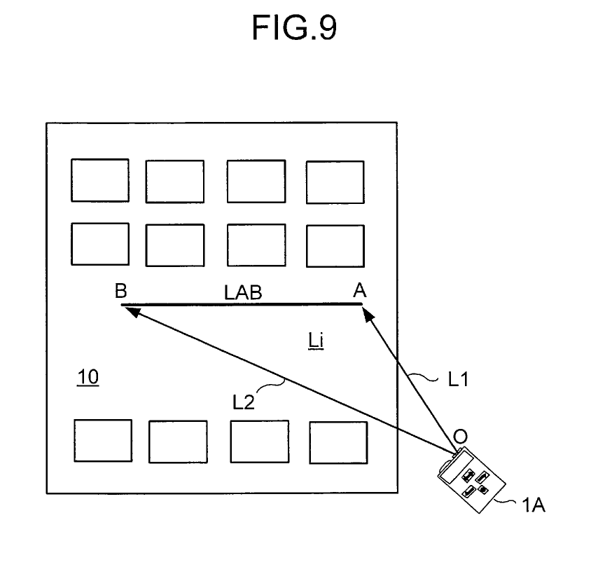

FIG. 9 shows an example of how the laser distance measurement apparatus 1A is used. FIG. 9 shows a building as the measurement target 10, and shows how, by use of the laser distance measurement apparatus 1A, a point-to-point distance LAB on a wall face of the building is measured in a non-contact fashion and a line segment AB on the measurement target 10 is pictorially indicated. The laser distance measurement apparatus 1A finds applications not only in the measurement of point-to-point distances on walls, pillars, etc. of buildings as just mentioned, but also in other fields. For example, with increased laser intensity and enhanced visibility, the laser distance measurement apparatus 1A can be used in land surveying, and in the measurement of slopes on mountains and hills.

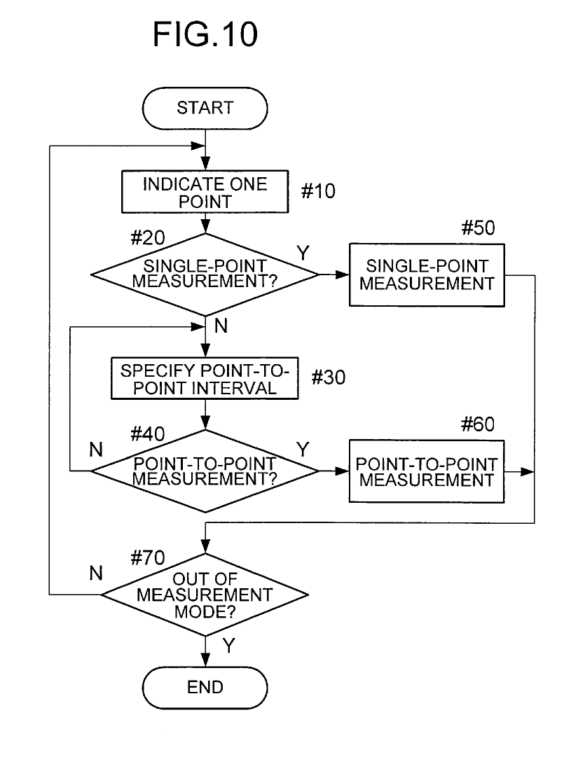

Next, with reference to the flow chart in FIG. 10, a description will be given of the control for switching measurement modes in the laser distance measurement apparatus 1A. The laser distance measurement apparatus 1A has two measurement modes for “single-point distance measurement” and “point-to-point distance measurement” respectively. As described above, when the user turns on the measurement start switch (unillustrated) of the laser distance measurement apparatus 1A, point A setting mode goes into effect, in which, as shown in FIG. 7A, the surface of the measurement target 10 is irradiated with laser light and a first laser spot is shown on it (#10). Then, whether or not the current measurement mode is single-point distance measurement mode is checked (#20), and if so, single-point distance measurement is performed (#50), on completion of which (#70), the control is ended.

If, at step #20, it is found that the current measurement mode is not single-point distance measurement mode, an interval between two points A and B (FIGS. 7B to 7D) is specified as described above (#30). Then, whether or not the current measurement mode is point-to-point distance measurement mode is checked (#40), and when it is in effect, point-to-point distance measurement is performed (#60), on completion of which (#70), the control is ended. In the point-to-point distance measurement (#60), the laser light Lr reflected from the two points A and B are each received by the photodiode 6, which then outputs signals; by use of these output signals and operation information on the scanner 3, the calculator-controller 7 calculates the distance LAB between the two points A and B.

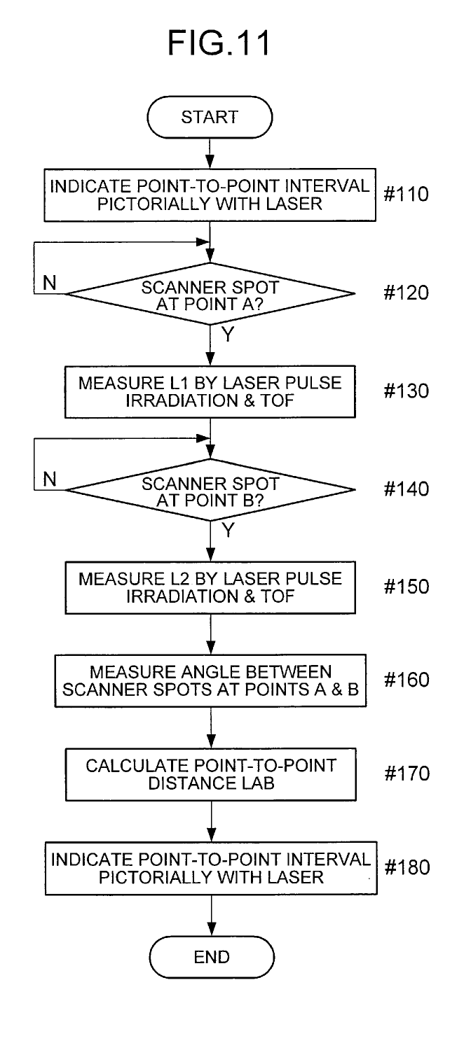

Next, with reference to the flow chart in FIG. 11, the control for the point-to-point distance measurement (#60) mentioned above will be described in more detail. With the interval between the two points pictorially indicated by laser scanning (continuous irradiation) by the scanner 3 (#110), whether the laser spot of the scanner 3 is at point A is checked (#120). When the laser spot is at point A, TOF measurement is performed by pulse emission to obtain the value of distance L1 (#130). In this embodiment, visible light is shared between distance measurement and pictorial indication, and therefore the laser diode 2 is now switched from continuous emission to pulse emission to perform TOF measurement. In a case where laser light of a wavelength other than infrared or the like is used in distance measurement, for example, a laser diode (for example, an infrared laser diode) for pulse emission is lit to perform TOF measurement.

On completion of the measurement of distance L1, whether or not the laser spot of the scanner 3 is at point B is checked (#140). When the laser spot is at point B, as with the above-mentioned measurement of distance L1, TOF measurement is performed by pulse emission to obtain the value of distance L2 (#150). The angle between the points A and B laser-indicated by the scanner 3 is then detected by a detecting means (for example, the encoder 3k) that suits the type of scanner 3 (#160). Now that the necessary values, namely the lengths L1 and L2 of two sides OA and OB of a triangle and the angle θ between those two sides, are known (see FIG. 3, etc.), the length of the third side, that is, the point-to-point distance LAB, is calculated according to the law of cosines (#170). The calculated point-to-point distance LAB is displayed on the display section 8 (see FIG. 6), and the point-to-point interval pictorially indicated by laser light remains indicated until the user gives a next instruction (#180).

As described above, the laser distance measurement apparatus 1A is so configured that two arbitrary points A and B on the measurement target 10 are irradiated one after the other by a scanner 3 capable of one-dimensional scanning, and this eliminates the need for complicated measurement maneuvering. It is thus possible to measure an arbitrary point-to-point distance LAB in a non-contact fashion by simple measurement maneuvering. Moreover, the laser distance measurement apparatus 1A is so configured that, with respect to the point-to-point distance LAB to be measured, the two points A and B which are its opposite ends, or the line segment AB between those two points, is pictorially indicated on the measurement target 10 by one-dimensional scanning with visible light, and this makes it possible to perform measurement while visually confirming where to measure. Using a two-dimensional scanner (for example, the MEMS scanner 3B shown in FIG. 5) as the scanner 3 makes it possible to pictorially indicate not only where to measure (two points A and B or line segment AB) but also values (for example, distances and other data), characters, symbols, etc.

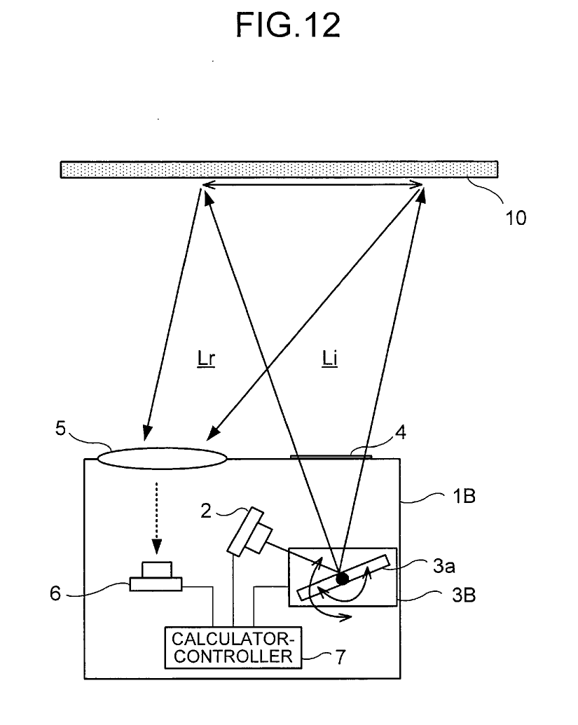

### Embodiment 2 (FIGS. 12 to 21)

FIG. 12 is a schematic diagram showing a laser distance measurement apparatus 1B incorporating the MEMS scanner 3B described previously as a two-dimensional scanner. The laser distance measurement apparatus 1B is a laser-radar distance measurement apparatus that is provided with a function of measuring the area of an arbitrary polygon on a measurement target 10 in a non-contact fashion, and is provided with a laser diode (LD) 2, a two-dimensional scanner (MEMS scanner) 3B, an emission window 4, a reception lens 5, a photodiode (PD) 6, a calculator-controller 7, etc.

The laser diode 2 serves as a light emitter that emits laser light, and is here assumed to be a visible-light laser diode that emits visible light as laser light. The light emitter may be constituted of an infrared laser diode that emits infrared light as laser light and a visible-light laser diode that emits visible light as laser light so that infrared light is used for distance measurement while visible light is used for pictorial indication. The two-dimensional scanner 3B is so configured as to reflect and thereby deflect, with a mirror 3a, the laser light from the laser diode 2 so that the surface of the measurement target 10 is scanned with the laser light two-dimensionally. A specific structure of the two-dimensional scanner 3B will be described in detail later.

The photodiode 6 serves as a light receiver that receives the laser light (the reflection light Lr) reflected from the measurement target 10 and outputs a signal. The calculator-controller 7 performs predetermined calculation based on output signals from the photodiode 6 etc. and operation information on the two-dimensional scanner 3B etc., and drives and controls the two-dimensional scanner 3B etc.

The laser light emitted from the laser diode 2 is reflected on the mirror 3a in the two-dimensional scanner 3B, and emerges through the emission window 4 as emission light Li, with which the measurement target 10 is irradiated. The laser light reflected from the measurement target 10 (the reflection light Lr) is condensed by the reception lens 5, and is detected by the photodiode 6. A signal based on the detection by the photodiode 6 is fed to the calculator-controller 7, which then calculates, among others, the distance from the laser distance measurement apparatus 1B to the measurement target 10.

In the measurement of the area of an arbitrary polygon on the measurement target 10, vertex-to-vertex distances of the polygon (that is, arbitrary point-to-point distances on the measurement target 10) are used. In the measurement of an arbitrary point-to-point distance on the measurement target 10, the distance from the laser distance measurement apparatus 1B to the measurement target 10 is used. And in the measurement of the distance from the laser distance measurement apparatus 1B to the measurement target 10, a TOF (time of flight) method is used.

As described previously (FIG. 2), suppose that the laser diode 2 and the photodiode 6 are located at equivalent positions, let the distance from the laser distance measurement apparatus 1B to the measurement target 10 be L, and let the time required for the laser light emitted from the laser diode 2 to return to the photodiode 6 after being reflected on the measurement target 10 (the go-and-return time between the laser distance measurement apparatus 1B and the measurement target 10) be Δt. Distance L is given by the formula L=(Δt/2)×c (where c represents the speed of light), and therefore determining time Δt makes it possible to determine distance L. The time Δt used in a TOF method is the difference in time between when the laser diode 2 emits light and when the photodiode 6 receives it, and can thus be calculated by the calculator-controller 7.

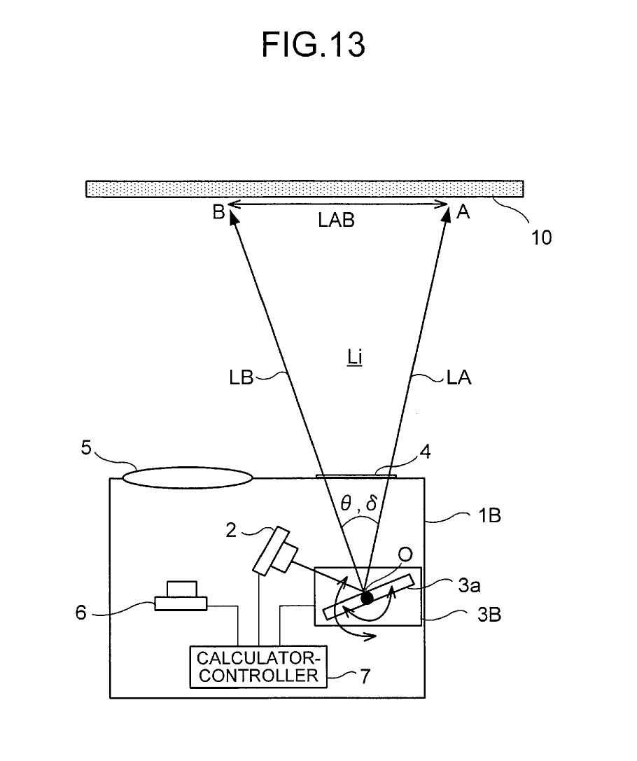

Furthermore, in the measurement of an arbitrary point-to-point distance on the measurement target 10, the angle between the line segments connecting the deflection position of the laser light (the position where the laser light is deflected) to the two arbitrary points respectively is used. As shown in FIG. 13, the two-dimensional scanner 3B is so configured as to deflect the laser light from the laser diode 2 in such a way that vertices A and B of an arbitrary polygon on the measurement target 10 are irradiated with the laser light and to scan the surface including the polygon two-dimensionally. Thus, the angles θ and δ between the line segments OA and OB connecting the deflection position O of the laser light Li to the two arbitrary points A and B respectively can be determined based on the swing angle of the two-dimensional scanner 3B.

As shown in FIG. 13, let the distance between the arbitrary points A and B (the length of line segment AB) be LAB, let the distance from the deflection position O of the laser light Li to point A (the length of line segment OA) be LA, and let the distance from the deflection position O of the laser light Li to point B (the length of line segment OB) be LB. Distances LA and LB can be calculated from the results of measurement by a TOF method (subtracting the distance from the laser diode 2 to the deflection position O from distance L gives distances LA and LB), and angles θ and δ can be determined based on the swing angle of the two-dimensional scanner 3B. Based on these values, the coordinates of the points are determined, and distance LAB between the two points A and B (that is, the length of side AB of that polygon) can be calculated.

As described previously, FIG. 5 shows a specific example of the two-dimensional scanner 3B used in the laser distance measurement apparatus 1B. The two-dimensional scanner 3B is a MEMS mirror capable of two-dimensional scanning. Known MEMS mirrors include those of an electromagnetic type, an electrostatic type, and a piezoelectric type. The example here is of the piezoelectric type. A MEMS mirror of the piezoelectric type can be driven either by resonance frequency or by voltage control (low frequency). In either way, the swing angle can be calculated based on the applied voltage.

The two-dimensional scanner 3B is, preferably, provided wirh a piezoelectric element that rotates the mirror 3a and so structured as to deflect the mirror 3a two-dimensionally by a combination of high-speed resonance driving and low-speed linear driving. With a scanner such as an MEMS mirror that drives a mirror with a piezoelectric element, it is easy to scan a measurement target with laser light at such a high speed as to leave an afterimage in the human eye, and it is also easy to control the deflection angle. By performing two-dimensional scanning by a combination of high-speed resonance driving and low-speed linear driving, it is possible to realize a compact, efficient scanner.

The two-dimensional scanner 3B is constituted of a substrate of etched silicon, with four pieces of PZT (lead zirconate titanate) 3e, as piezoelectric elements, bonded on the substrate to form four unimorphs extending from a fixed frame 3d. The four unimorphs are, at their portions along the X axis, coupled to a mirror holding frame 3c, and in the mirror holding frame 3c, a mirror 3a is provided on a torsion bar 3b.

In reflecting and thereby deflecting laser light with the mirror 3a, the two-dimensional scanner 3B displaces the four PZT pieces 3e to make the mirror holding frame 3c rotate about the X axis, and thereby achieves vertical (longitudinal) scanning in raster scanning (fV=60 Hz). Simultaneously, the two-dimensional scanner 3B applies vibration at the resonance frequency (fH=30 kHz) of the oscillating portion constituted of the mirror 3a and the torsion bar 3b to induce resonant vibration about the Y axis, and thereby achieves horizontal (lateral) scanning in raster scanning.

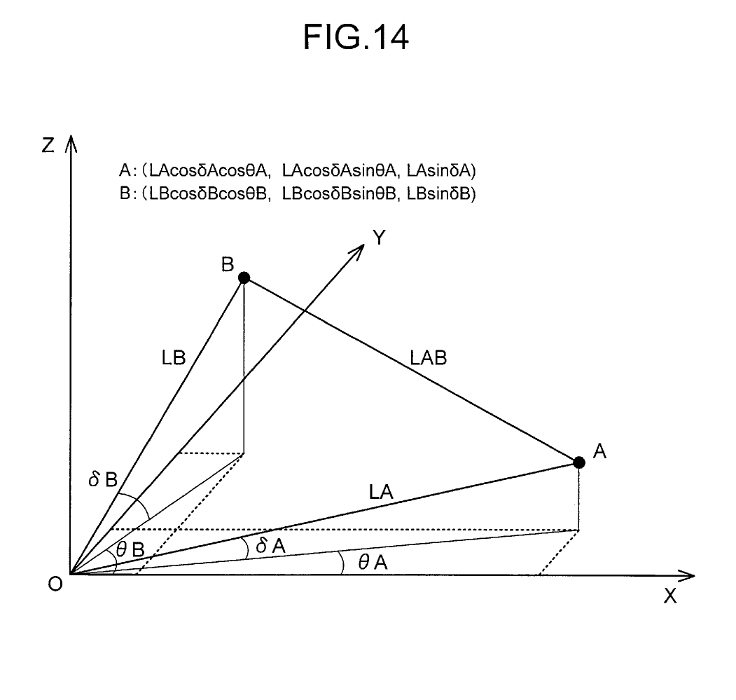

As described previously (FIG. 13), based on distances LA and LB and angles θ and δ, the coordinates of the two points A and B are determined. FIG. 14 shows the coordinates of two arbitrary points A and B (that is, the coordinates of vertices of an arbitrary polygon) on the measurement target 10. The swing angle of the two-dimensional scanner 3B corresponds to the angles θ and δ between line segments OA and OB, and therefore based on distances LA and LB mentioned above and the swing angles θA, δA, θB, and δB of the two-dimensional scanner 3B, it is possible to calculate the coordinates of the two points A and B as follows:
A: (LA cos δA cos θA, LA cos δA sin θA, LA sin δA)
B: (LB cos δB cos θB, LB cos δB sin θB, LB sin δB)

Let the coordinates of the above two points A and B be
A: (A1, A2, A3)
B: (B1, B2, B3)
   Then, the distance LAB between the two points A and B can be calculated according to the formula

LAB=\sqrt{(B1−A1)²+(B2−A2)²+(B3−A3)²}

Vertex-to-vertex distances of an arbitrary polygon on the measurement target 10, which are necessary for the measurement of the area of the polygon, are calculated in the manner described above.

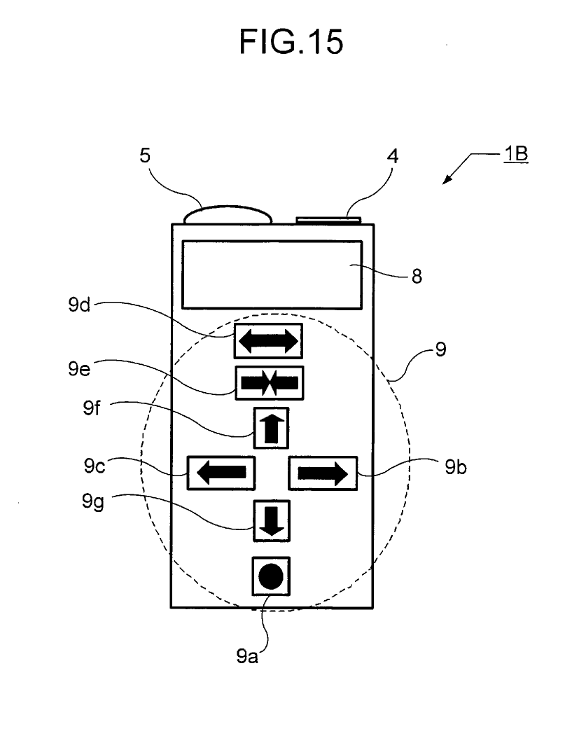

FIG. 15 shows the exterior appearance of the laser distance measurement apparatus 1B. The laser distance measurement apparatus 1B is, on the surface of its casing, provided with a display section 8, an operation section 9, etc. The display section 8 is a section that displays, among others, the result of measurement of an area, a vertex-to-vertex distance, etc. The operation section 9 is a section that the user operates to move the spot irradiated with the laser light Li (FIGS. 2, 12, and 13) to specify vertex positions of the polygon to be measured; having specified the vertex positions, the user then operates the operation section 9 to start area measurement. As buttons for allowing such operations, there are arranged a set button 9a, a shift right button 9b, a shift left button 9c, a lengthen button 9d, a shorten button 9e, a shift up button 9f, and a shift down button 9g in the operation section 9.

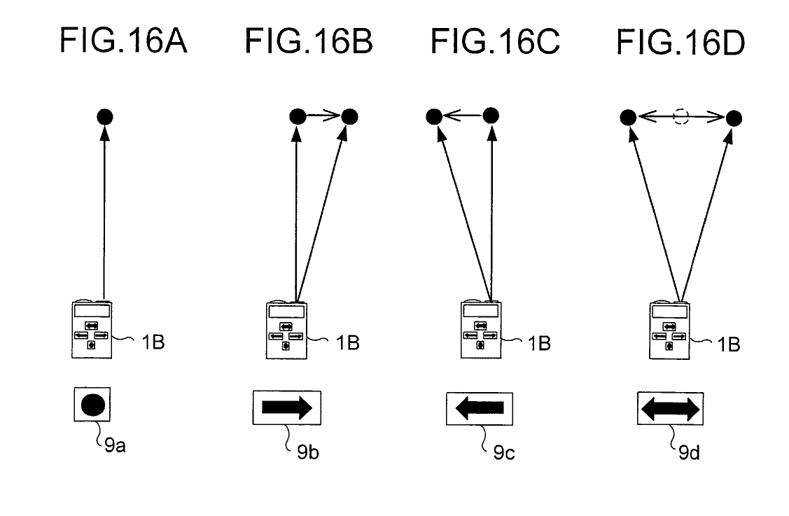

Next, a description will be given of how the user specifies vertex positions, such as two points A and B (FIG. 14), of a polygon on the operation section 9. When the user turns on a measurement start switch (unillustrated) of the laser distance measurement apparatus 1B, point A setting mode goes into effect. In point A setting mode, as shown in FIG. 16A, the surface of the measurement target 10 (FIG. 13) is irradiated with laser light and a first laser spot is shown on it. The user moves the laser distance measurement apparatus 1B to set the laser spot at point A. With the first laser spot set at point A, the user presses the set button 9a. This puts point B setting mode into effect.

In point B setting mode, a second laser spot is shown superimposed on the first laser spot. To set the second laser spot at point B, the user uses the shift right button 9b, the shift left button 9c, the lengthen button 9d, the shorten button 9e, the shift up button 9f, and the shift down button 9g. For example, if the user wants to move the second laser spot rightward, as shown in FIG. 16B, he can do so by pressing the shift right button 9b. If the user wants to move the second laser spot leftward, as shown in FIG. 16C, he can do so by pressing the shift left button 9c. If the user wants to move the second laser spot upward, he can do so by pressing the shift up button 9f (FIG. 15), and if the user wants to move the second laser spot downward, he can do so by pressing the shift down button 9g (FIG. 15). If the user wants to lengthen the interval between the first and second laser spots, as shown in FIG. 16D, he can do so by pressing the lengthen button 9d. Inversely, if the user wants to shorten the interval between the first and second laser spots, he can do so by pressing the shorten button 9e (FIG. 15).

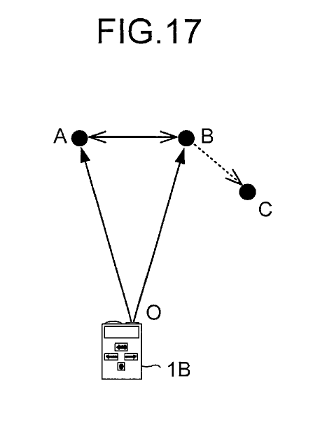

With the first and second laser spots set at positions A and B, the user presses the set button 9a to put point C setting mode into effect. The third and any subsequent vertex positions are set in a similar manner as with point B as described above. For example, in a case where, as shown in FIG. 17, point C is located to the lower right of point B, the user presses the shift right button 9b and the shift down button 9g to move the laser spot and, when the three laser spots are set at points A to C respectively, the user presses the set button 9a to put point D setting mode into effect. To specify the last vertex position of the polygon, the user presses the set button 9a twice; this completes the specifying of all the vertex positions of the polygon (instead, the number of vertices of the polygon may be entered first so that, when the last vertex position is specified, the specifying of all the vertex positions is completed). When the distance measurement positions with respect to all the vertices of the polygon have been determined, the measurement of the distance from the deflection position O to each vertex of the polygon (measurement operation by a TOF method) is started.

Since the laser light emitted from the laser diode 2 is visible light, by making the two-dimensional scanner 3B perform two-dimensional scanning with it, it is possible to pictorially indicate the polygon or its vertices on the measurement target 10. That is, a display function like that of a projector is provided, and this permits the user to determine the coordinates of one vertex of a polygon after another while pictorially indicating the polygon or its vertices.

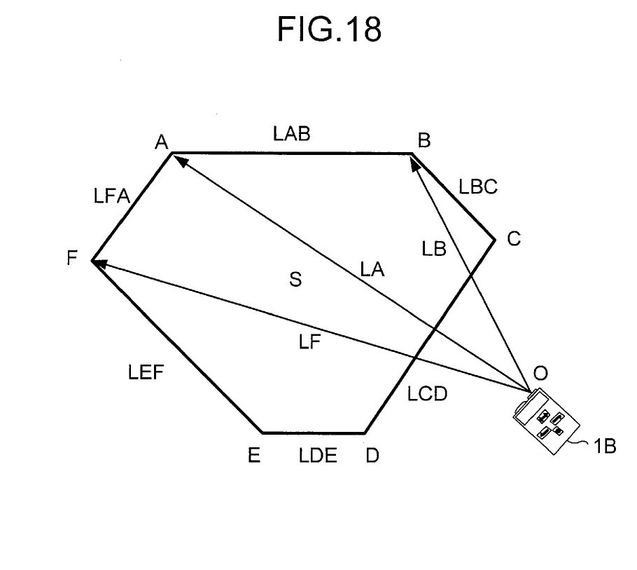

FIG. 18 shows an example of a polygon (here, a hexagon) pictorially indicated by laser-scanning. As shown in FIG. 18, by laser-scanning, it is possible to pictorially indicate, as a line segment (corresponding to the length being measured), each side of a polygon (outline), and thereby indicate the polygon ABCDEF of which the area S is currently being measured, the sides AB, BC, . . . , and FA of which the vertex-to-vertex distances LAB, LBC, . . . , and LFA are currently being measured, etc. Also by pictorially indicating only the vertices of polygon ABCDEF, it is possible to indicate the area S and the vertex-to-vertex distances LAB, LBC, . . . , and LFA currently being measured. When displaying the polygon by laser-scanning, it is possible to pictorially indicate, in addition to the position, shape, etc. of the polygon of which the area etc. are to be measured, also values (for example, distances, areas, and other data), characters, symbols, etc.

The pictorial indication described above is achieved by controlling the light emission timing of the laser diode 2. It may instead be achieved by controlling the swing angles θ and δ of the two-dimensional scanner 3B. That is, the pictorial indication is achieved by the calculator-controller 7 (FIGS. 12 and 13) controlling at least either the light emission timing of the laser diode 2 or the swing angles θ and δ of the two-dimensional scanner 3B.

In a case where the pictorial indication is achieved by controlling the light emission timing of the laser diode 2, while the two-dimensional scanner 3B is operating, the mirror 3a keeps vibrating with fixed rotation angles Θ and Δ(Θ>θ and Δ>δ); meanwhile, a detecting means that suits the type of two-dimensional scanner 3B detects the swing angles θ and δ, and the laser diode 2 emits light with predetermined timing. On the other hand, in a case where the pictorial indication is achieved by controlling the swing angles θ and δ of the two-dimensional scanner 3B, while the two-dimensional scanner 3B is operating, a detecting means detects the swing angles θ and δ, and the mirror 3a vibrates with rotation angles Θ and Δ corresponding to the light emission of the laser diode 2 (Θ>θ and Δ>δ). Accordingly, for example, in the state shown in FIG. 16A, Θ=Δ=0°.

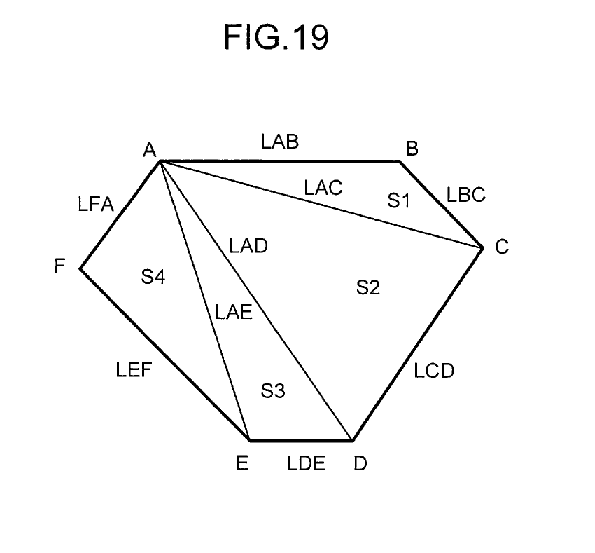

Next, a description will be given of how the area of an arbitrary polygon is calculated based on the lengths of sides or diagonals (that is, vertex-to-vertex distances) of the polygon. Consider an n-cornered (that is, n-sided) polygon (3≦n). An n-cornered polygon can be divided into (n−2) triangles along one or more diagonals. Accordingly, the polygon in question is divided into a plurality of triangles along one or more diagonals starting at one predetermined vertex. For example, in the case of hexagon ABCDEF shown in FIG. 19, it is divided into four triangles ABC, ACD, ADE, and AEF along the diagonals AC, AD, and AE starting at vertex A. Let the areas of the four triangles ABC, ACD, ADE, and AEF sharing vertex A be S1, S2, S3, and S4 respectively. Then, the area S of hexagon ABCDEF shown in FIG. 19 is given by the formula S=S1+S2+S3+S4.

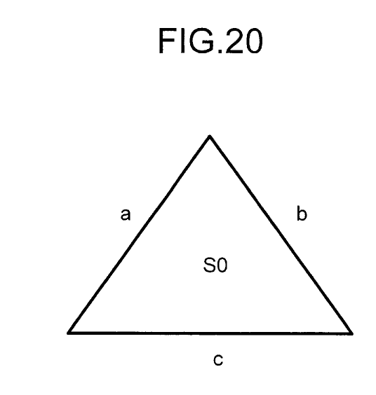

The areas of the divided triangles are calculated according to Heron's formula. For example, as shown in FIG. 20, the area S0 of a triangle having sides with lengths a, b, and c respectively is calculated as follows by Heron's formula:

$$S 0 = \sqrt{s 0 ( s 0 - a ) ( s 0 - b ) ( s 0 - c )} , where s 0 = \frac{a + b + c}{2}$$

In the case of hexagon ABCDEF shown in FIG. 19, the length of the three sides of each of the four triangles ABC, ACD, ADE, and AEF can be calculated based on the coordinates of the vertices as described previously. Thus, the areas S1, S2, S3, and S4 of triangles ABC, ACD, ADE, and AEF are given by the formulae noted below, and the area S of hexagon ABCDEF is given by the above-noted formula S=S1+S2+S3+S4.

$$S 1 = \sqrt{s 1 ( s 1 - LAB ) ( s 1 - LBC ) ( s 1 - LAC )} , where$$

$$s 1 = \frac{LAB + LBC + LAC}{2}$$

$$S 2 = \sqrt{s 2 ( s 2 - LAC ) ( s 2 - LCD ) ( s 2 - LAD )} , where$$

$$s 2 = \frac{LAC + LCD + LAD}{2}$$

$$S 3 = \sqrt{s 3 ( s 3 - LAD ) ( s 3 - LDE ) ( s 3 - LAE )} , where$$

$$s 3 = \frac{LAD + LDE + LAE}{2}$$

$$S 4 = \sqrt{s 4 ( s 4 - LAE ) ( s 4 - LEF ) ( s 4 - LFA )} , where$$

$$s 4 = \frac{LAE + LEF + LFA}{2}$$

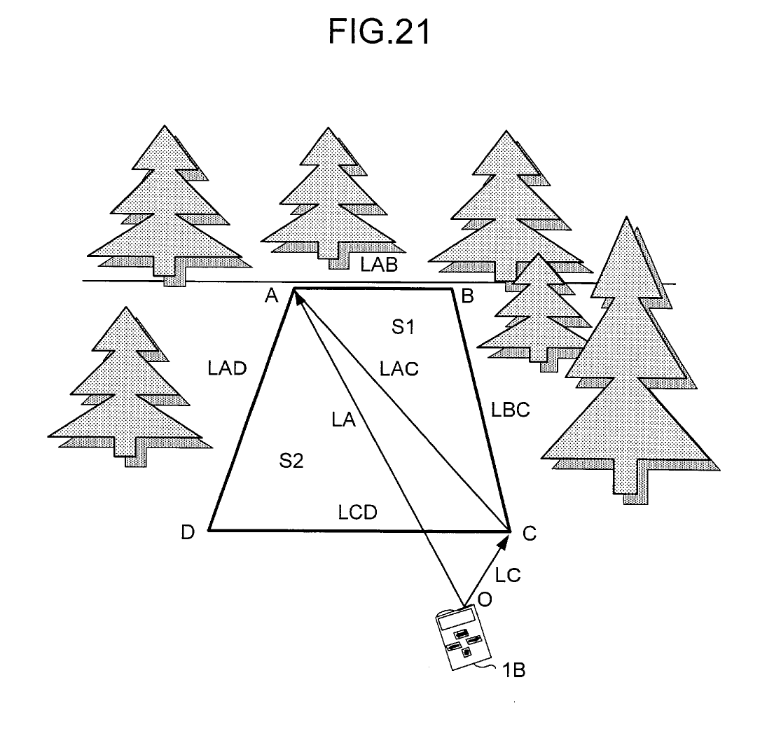

FIG. 21 shows an example of how the laser distance measurement apparatus 1B is used. Uses that require easy, non-contact measurement of areas include those in land survey. FIG. 21 shows a case where the area of a piece of land in the shape of a rectangular ABCD is measured in a non-contact fashion and rectangular ABCD is pictorially indicated on the ground. Rectangular ABCD is divided into two triangles ABC and ACD, of which the areas S1 and S2 respectively are given by the formulae noted below, and the area S of rectangular ABCD is given by the formula S=S1+S2.

$$S 1 = \sqrt{s 1 ( s 1 - LAB ) ( s 1 - LBC ) ( s 1 - LAC )} , where$$

$$s 1 = \frac{LAB + LBC + LAC}{2}$$

$$S 2 = \sqrt{s 2 ( s 2 - LAC ) ( s 2 - LCD ) ( s 2 - LAD )} , where$$

$$s 2 = \frac{LAC + LCD + LAD}{2}$$

The laser distance measurement apparatus 1B finds uses not only for the measurement of areas of land as described above, but also in other fields. For example, in a situation where the floor layout in an office is changed, the laser distance measurement apparatus 1B is convenient to measure the areas of floor faces and wall faces. Moreover, since the laser distance measurement apparatus 1B is capable of two-dimensional scanning, it can pictorially indicate not only values, characters, symbols, etc. as described above but also, in land survey, ambient images (trees, rocks, mountains, rivers, etc.) and, in floor layout planning, desks, racks, chairs, etc. In the measurement of areas, surface irregularity in the depth direction produce errors, and therefore it is preferable that the measurement target 10 be as flat as possible.

As described above, the laser distance measurement apparatus 1B is so configured that the vertices of an arbitrary polygon on the measurement target 10 are irradiated by the scanner 3B which is capable of two-dimensional scanning, and this eliminates the need for complicated measurement maneuvering. Thus, it is possible to measure the area of an arbitrary polygon in a non-contact fashion by simple measurement maneuvering. Moreover, the laser distance measurement apparatus 1B is so configured that, with respect to the polygon of which the area is to be measured, the polygon itself or its vertices are pictorially indicated on the measurement target 10 by two-dimensional scanning with visible light, and this makes it possible to perform measurement by visually confirming where to measure. Since the vertex positions of the polygon can be specified by operation of buttons, by reducing the number of measurement points as necessary, it is possible to reduce the time required by calculation processing.

What is claimed is:

1. A laser-radar distance measurement apparatus for measuring a distance between two arbitrary points on a measurement target in a non-contact fashion, comprising:
a light emitter for emitting laser light;
a scanner for deflecting the laser light from the light emitter to irradiate with the laser light the two arbitrary points on the measurement target one after the other, the scanner being capable of one-dimensional scanning along a straight line including the two arbitrary points;
a light receiver for receiving the laser light reflected from the two arbitrary points to output signals respectively; and
a calculation controller for calculating the distance between the two arbitrary points based on the signals output from the light receiver and operation information on the scanner.

2. The apparatus according to claim 1, wherein the calculation controller calculates the distance between the two arbitrary points based on distances from a deflection position of the laser light to the two arbitrary points respectively and an angle between line segments connecting the deflection position of the laser light to the two arbitrary points respectively.

3. The apparatus according to claim 2, wherein the calculation controller calculates the distances from the deflection position of the laser light to the two arbitrary points by a TOF method, and detects the angle between the line segments based on a swing angle of the scanner.

4. The apparatus according to claim 1, wherein the light emitter comprises a laser diode that emits visible light as the laser light, and the scanner pictorially indicate the two arbitrary points or a line segment between the two arbitrary points on the measurement target by one-dimensional scanning with the visible light.

5. The apparatus according to claim 4, wherein the pictorial indication is achieved by the calculation controller controlling at least either light emission timing of the laser diode or a swing angle of the scanner.

6. The apparatus according to claim 1, wherein the light emitter comprises an infrared laser diode that emits infrared light as the laser light and a visible-light laser diode that emits visible light as the laser light, and the scanner pictorially indicate the two arbitrary points or a line segment between the two arbitrary points on the measurement target by one-dimensional scanning with the visible light.

7. The apparatus according to claim 6, wherein the pictorial indication is achieved by the calculation controller controlling at least either light emission timing of the visible-light laser diode or a swing angle of the scanner.

8. The apparatus according to claim 1, wherein the scanner is a one-dimensional scanner that reflects and thereby deflects laser light with a mirror.

9. The apparatus according to claim 1, wherein the scanner is a two-dimensional scanner that reflects and thereby deflects laser light with a mirror, and irradiates the two arbitrary points with the laser light by deflecting the laser light only in one scanning direction.

10. A laser-radar distance measurement apparatus for measuring an area of an arbitrary polygon on a measurement target in a non-contact fashion, comprising:
a light emitter for emitting laser light;
a scanner for deflecting the laser light from the light emitter to irradiate with the laser light vertices of the arbitrary polygon on the measurement target, the scanner being capable of two-dimensional scanning on a surface including the arbitrary polygon;
a light receiver for receiving the laser light reflected from the vertices of the arbitrary polygon to output signals respectively; and
a calculation controller for calculating the area of the arbitrary polygon based on the signals output from the light receiver and operation information on the scanner.

11. The apparatus according to claim 10, wherein the calculation controller calculates the area of the arbitrary polygon based on lengths of sides or diagonals of the arbitrary polygon.

12. The apparatus according to claim 11, wherein the calculation controller measures distances from a deflection position of the laser light to the vertices of the polygon respectively by a TOF method, detects, from a swing angle of the two-dimensional scanner, an angle between line segments connecting the deflection position of the laser light to both ends, respectively, of each of the sides or diagonals, and calculates a length of each of the sides or diagonals based on the distances from the deflection position of the laser light to the vertices, respectively, of the polygon and the angle between the line segments connecting the deflection position of the laser light to both ends, respectively, of the corresponding one of the sides or diagonals.

13. The apparatus according to claim 10, wherein the light emitter comprises a laser diode that emits visible light as the laser light, and the scanner pictorially indicate the arbitrary polygon or the vertices of the polygon on the measurement target by two-dimensional scanning with the visible light.

14. The apparatus according to claim 13, wherein the pictorial indication is achieved by the calculation controller controlling at least either light emission timing of the laser diode or a swing angle of the scanner.

15. The apparatus according to claim 10, wherein the light emitter comprises an infrared laser diode that emits infrared light as the laser light and a visible-light laser diode that emits visible light as the laser light, and the scanner pictorially indicate the arbitrary polygon or the vertices of the polygon on the measurement target by two-dimensional scanning with the visible light.

16. The apparatus according to claim 15, wherein the pictorial indication is achieved by the calculation controller controlling at least either light emission timing of the visible-light laser diode or a swing angle of the scanner.

17. The apparatus according to claim 10, wherein the scanner is a two-dimensional scanner that reflects and thereby deflects laser light with a mirror.

18. The apparatus according to claim 17, wherein the scanner comprises a piezoelectric element that rotates the mirror, and deflects the mirror two-dimensionally by a combination of high-speed resonance driving and low-speed linear driving.
